(19) United States
(12) Patent Application Publication
(10) Pub. No.: US 2024/0126520 A1
(43) Pub. Date: Apr. 18, 2024

(54) METHODS AND APPARATUS TO COMPILE PORTABLE CODE FOR SPECIFIC HARDWARE

(71) Applicant: Intel Corporation, Santa Clara, CA (US)

(72) Inventors: Fabian Oboril, Karlsruhe (DE); Cornelius Buerkle, Karlsruhe (DE)

(21) Appl. No.: 18/399,033

(22) Filed: Dec. 28, 2023

(51) Int. Cl. G06F 8/41

(52) U.S. Cl. CPC G06F 8/41

(57) ABSTRACT

Systems, apparatus, articles of manufacture, and methods are disclosed that compile portable code for specific hardware are disclosed herein that include an apparatus including computer readable instructions, and programmable circuitry to at least one of execute or instantiate the instructions to receive input code, the input code written for operation on a first platform, determine a target platform, the target platform different than the first platform, and translate, via an artificial intelligence (AI) model, the input code to output code, the output code written for operation on the target platform.

### FIELD OF THE DISCLOSURE

This disclosure relates generally to computer hardware and, more particularly, to methods and apparatus to compile portable code for specific hardware.

### BACKGROUND

In recent years, electronic devices have executed machine-readable instructions to perform functions. Different electronic devices may use different machine-readable instruction formats based on different features available to the different electronic devices.

### BRIEF DESCRIPTION OF THE DRAWINGS

FIG. 1 is a block diagram of an example environment in which an example compiler adapter circuitry operates to perform software code translation based on specific hardware.

FIG. 2 is a block diagram of an example implementation of the compiler adapter circuitry of FIG. 1 to compile portable code for specific hardware.

FIG. 3 is a sequence diagram of the inputs and outputs of a single-stage artificial intelligence (AI) model that is used by the compiler adapter circuitry of FIG. 1.

FIG. 4 is a diagram representing an example internal structure of the single-stage AI model of FIG. 3.

FIG. 5 is a sequence diagram of the inputs and outputs of a multi-stage AI model that is used by the compiler adapter circuitry of FIG. 1.

FIG. 6 is a diagram representing an example semantic output generated by the multi-stage AI model of FIG. 5.

FIG. 7 is a diagram representing an example of input code, semantic output, and output code corresponding to the multi-stage AI model of FIG. 5.

FIG. 8 is an example user interface displaying example metrics of the output code comparing the function and the corresponding CPU time.

FIG. 9 is an example sequence diagram of compiler adapter circuitry using metrics of the output code being executed on instances of the target platforms.

FIG. 10 is a flowchart representative of example machine readable instructions and/or example operations that may be executed, instantiated, and/or performed by example programmable circuitry to implement the compiler adapter circuitry of FIG. 2.

FIG. 11 is a block diagram of an example processing platform including programmable circuitry structured to execute, instantiate, and/or perform the example machine readable instructions and/or perform the example operations of FIG. 10 to implement the compiler adapter circuitry of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIG. 10 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Electronic devices execute machine readable instructions (e.g., software, code, software code, etc.) to operate. In some examples, the machine readable instructions are written in a first programming language (e.g., C, C++, Python, Java, CUDA, one API, etc.) for execution on an electronic device that is capable of executing the first programming language. In some examples, the machine readable instructions are written based on a platform. As used herein, a platform may be a virtual platform (e.g., virtual computing servers), a software platform (e.g., software structures), or a hardware platform (e.g., hardware architectures).

For example, the machine readable instructions may be written for a first laptop that supports pipelined data. However, the user may have a second laptop that supports a data-parallel data rather than pipelined data. The user may use the techniques disclosed herein to port the code from the first laptop to the second laptop. Porting code (e.g., adapting code, translating code, etc.) may be performed from a first programming language to a second language, or from a first hardware architecture to a second hardware architecture. A first example hardware difference includes support for at least one of the suite of advanced vector extensions (e.g., AVX512, AVX2, and AVX). A second example hardware difference includes the ability for the hardware to use branches (e.g., if the code should avoid branches, a quality of branch prediction). A third example hardware difference includes overlaying computations and memory accesses to result in double buffering.

In some examples, some code is portable, or able to be translated to other programming languages or for use with other computer platforms (e.g., hardware architectures, software structures, virtual computing servers). However, some portable code is not tuned (e.g., optimized) for use with the other computer platforms. The techniques disclosed herein improve the portable code to use the features available present in the other computer platforms (e.g., the target platforms).

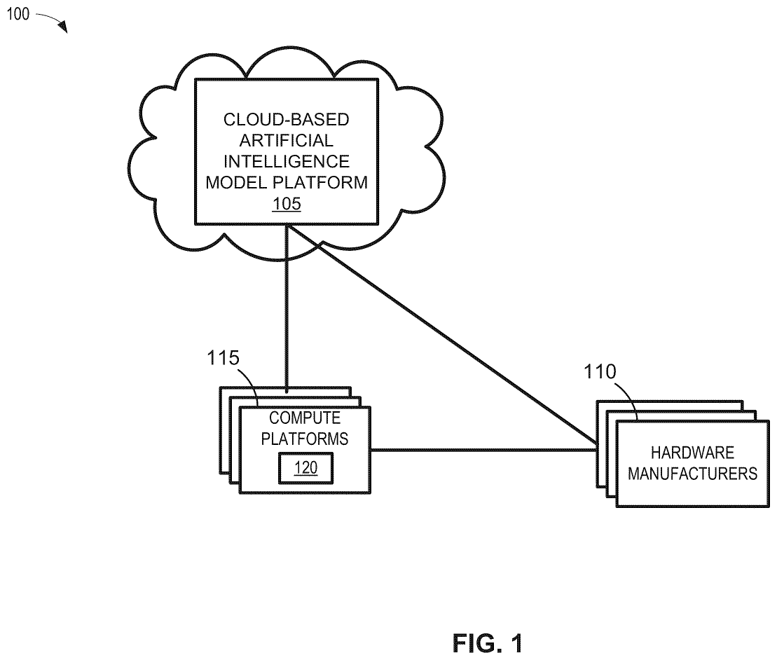

FIG. 1 is a block diagram of an example environment 100 in which example compiler adapter circuitry 120 operates to perform software code translation based on specific hardware. The example environment 100 includes an example cloud-based AI model platform 105, example hardware manufacturers 110, and example compute platforms 115. The example compute platforms 115 include the example compiler adapter circuitry 120. In the example of FIG. 1, the example cloud-based AI model platform 105 is in communication with the example hardware manufacturers 110 and the example compute platforms 115. The example hardware manufacturers 110 are in communication with the example compute platforms 115.

In some examples, the compute platforms 115 retrieve information regarding the platforms (e.g., hardware platforms, software platforms, virtual platforms) directly from the example hardware manufactures 110. In some examples, the cloud-based AI model platform retrieves information regarding the platforms from the example hardware manufacturers 110 to update the AI model. In some examples, the compute platforms 115 perform the software code translation (e.g., software porting) locally from a first compute platform to a second compute platform. In other examples, the compute platforms 115 use the cloud-based AI model platform 105 to perform the software code translation.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a translational large language model is used. Using a translational large language model enables various code segments to be translated to other code segments. In some examples disclosed herein, an autoregressive model is used. Using an autoregressive model enables various code segments to be translated to semantic meaning and then translate the semantic meaning into other code segments. In general, machine learning models/architectures that are suitable to use in the example approaches disclosed herein will be able to use transformer structure that includes at least one of either an encoder or a decoder. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error is achieved. In some examples, training is performed continuously on live outputs. In some examples disclosed herein, training is performed at the example cloud-based artificial intelligence model platform 105 (FIG. 1) (e.g., remote facility). In some examples disclosed herein, training is performed at the example compute platforms 115 (FIG. 1) (e.g., local devices). Training is performed using hyperparameters that control how the learning is performed (e.g., a learning rate, a number of layers to be used in the machine learning model, etc.). In some examples re-training may be performed. Such re-training may be performed in response to not the results not exceeding a threshold performance score.

Training is performed using training data. In examples disclosed herein, the training data originates from locally compute platforms 115 (FIG. 1). In some examples, the training data originates from hardware manufacturers 110 (FIG. 1). In some examples, the training is supervised. In some examples, the training is unsupervised.

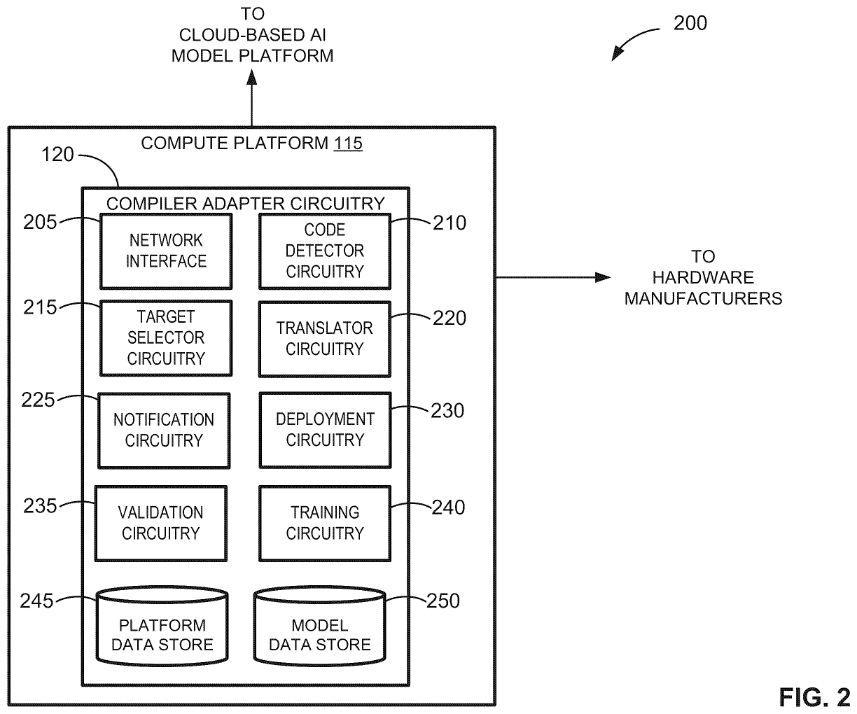

Once training is complete, the model is deployed for use as an executable construct that processes an input and provides an output based on the network of nodes and connections defined in the model. The model is stored at the cloud-based AI model platform 105 (FIG. 1). In some examples, the model is stored at the example model data store 250 (FIG. 2). The model may then be executed by the cloud-based AI model platform 105 (FIG. 1). In some examples, the translator circuitry 220 (FIG. 2) executes the model.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

FIG. 2 is a block diagram 200 of an example implementation of the compiler adapter circuitry 120 of FIG. 1 to compile portable code for specific hardware. The compiler adapter circuitry 120 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the compiler adapter circuitry 120 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example compiler adapter circuitry 120 includes an example network interface 205, example code detector circuitry 210, example target selector circuitry 215, example translator circuitry 220, example notification circuitry 225, example deployment circuitry 230, example validation circuitry 235, example training circuitry 240, an example platform data store 245, and an example model data store 250.

The example network interface 205 may communicate with the example cloud-based AI model platform 105 (FIG. 1) and/or the hardware manufacturers 110 (FIG. 1) by using a Wi-FI connection, Bluetooth connection, an Ethernet connection, a digital subscriber line (DSL) connection, a telephone line connection, a coaxial cable system, a satellite system, a line-of-site wireless system, a cellular telephone system, an optical connection, etc. to transmit (e.g., upload, download, access, retrieve) input code, output code, AI models, and platform information.

The example code detector circuitry 210 is to receive input code. In some examples, the input code is written for operation on a first platform (e.g., source platform). The example code detector circuitry 210 may periodically determine that there is input code to update (e.g., translate, port, adapt) for a target platform. In some examples, the code detector circuitry 210 determines that there is input code based on a user input received at the notification circuitry 225.

The example target selector circuitry 215 is to determine a target platform that is different than the first platform. In some examples, the target selector circuitry 215 compares features available in the target platform with the first platform. In such examples, the target selector circuitry 215 stores the features available in the two platforms as a platform description. The platform description is used by the example translator circuitry to verify that the features available in the target platform are utilized in the adapted code (e.g., output code, translated code, ported code). In some examples, the source platform is a first hardware platform (e.g., a NVIDIA® platform) and the target platform is a second hardware platform (e.g., an INTEL® platform).

The example translator circuitry 220 is to, by using an artificial intelligence (AI) model, translate the input code to the output code that is written for operation on the target platform. In some examples, the translator circuitry 220 uploads the input code to the cloud-based AI model platform 105 (FIG. 1) and downloads the output code from the cloud-based AI model platform 105 (FIG. 1). In some examples, the translator circuitry 220 translates the input code using a sequence-to-sequence AI model to translate the input code to the output code without generation of an intermediate result. In some examples, the translator circuitry 220 is to translate the input code using a multi-stage AI model, the multi-stage AI model to include at least a first stage and a second stage. In such examples, the first stage of the multi-stage AI model is to translate the input code to semantic data and the second stage of the multi-stage AI model is to translate the semantic data to the output code.

In some examples, the translator circuitry 220 is to use at least one of the input code, documentation corresponding to the input code, and a flowchart corresponding to the input code as an input to generate the semantic data. In such examples, the translator circuitry 220 uses at least one of target platform information retrieved (e.g., sourced) from the target selector circuitry 215 and the semantic data as inputs to generate the output code. In some examples, after user input is received by the notification circuitry 225, the translator circuitry 220 is to adjust the semantic data. By adjusting the semantic data, the translator circuitry 220 determines a meaning corresponding to the input code. In some examples, the translator circuitry 220 determines a meaning corresponding to a first section of the input code and rewrites the first section of the input code to use a first feature that is available in the target platform where the first feature is absent from the first platform. In some examples, the translator circuitry 220 generates the output code as binary code that is directly executable on the target platform. In some examples, the input code is in a first programming language (e.g., C++), and the translator circuitry 220 generates the output code in the first programming language (e.g., C++). In some examples, the input code is in a first programming language (e.g., CUDA), and the translator circuitry 220 generates the output code in a second programming language (e.g., oneAPI).

The example notification circuitry 225 is to inform a user that the semantic data is available for inspection. In some examples, the notification circuitry 225 causes display of a message (e.g., presents a message) that informs a user that the semantic data is available for inspection. The example notification circuitry 225 is to receive information from a user. For example, after presenting the semantic data to the user, the notification circuitry 225 may receive an instruction from the user that the semantic data is accurate for the input code. In other examples, after presenting the semantic data to the user, the notification circuitry 225 may receive an instruction from the user that the semantic data is not accurate for the input code. In such examples, the notification circuitry 225 instructs the translator circuitry 220 to perform a subsequent translation of the input code to the semantic data.

The example deployment circuitry 230 is to deploy the output code on a first instance of the target platform. By deploying the output code, the deployment circuitry 230 improves the functioning of the target platform (e.g., compute device, software structure, hardware architecture) by allowing the target platform to execute the code that is tuned for the target platform. In some examples, the deployment circuitry 230 may use the network interface 205 to send the output code to a remote target platform.

The example validation circuitry 235 is to record a performance metric of the output code in operation on the first instance of the target platform. For example, the validation circuitry 235 compares a first output of the input code and a second output of the output code. By comparing the outputs of the input code and output code, the example validation circuitry 235 is to validate the output code by determining if the output code generates a second output that corresponds to the first output of the input code. If the example second output (e.g., the result of the output code) corresponds to the first output (e.g., the result of the input code), then the validation circuitry 235 determines that the output code is accurate. If the example second output (e.g., the result of the output code) does not correspond to the first output (e.g., the result of the input code), then the validation circuitry 235 determines that the output code is inaccurate. In such examples, the validation circuitry 235 may record performance metrics relating to the input code and the output code being executed on the source platform and the target platform.

The example training circuitry 240 is to train the AI models used by the translator circuitry 220. For example, the training circuitry 240 may train the AI models based on the performance metric of the output code, the performance metric to include at least one of accuracy, temperature, power, and speed.

The example platform data store 245 is to store the information relating to the various platforms (e.g., hardware platforms, software platforms, virtual platforms). For example, the target selector circuitry 215 stores the platform description in the platform data store 245.

The example model data store 250 is to store the AI models used by the translator circuitry 220. In some examples, the AI models are local AI models. In other examples, the AI models are downloaded from the cloud-based AI platform 105 (FIG. 1) and stored in the model data store 250.

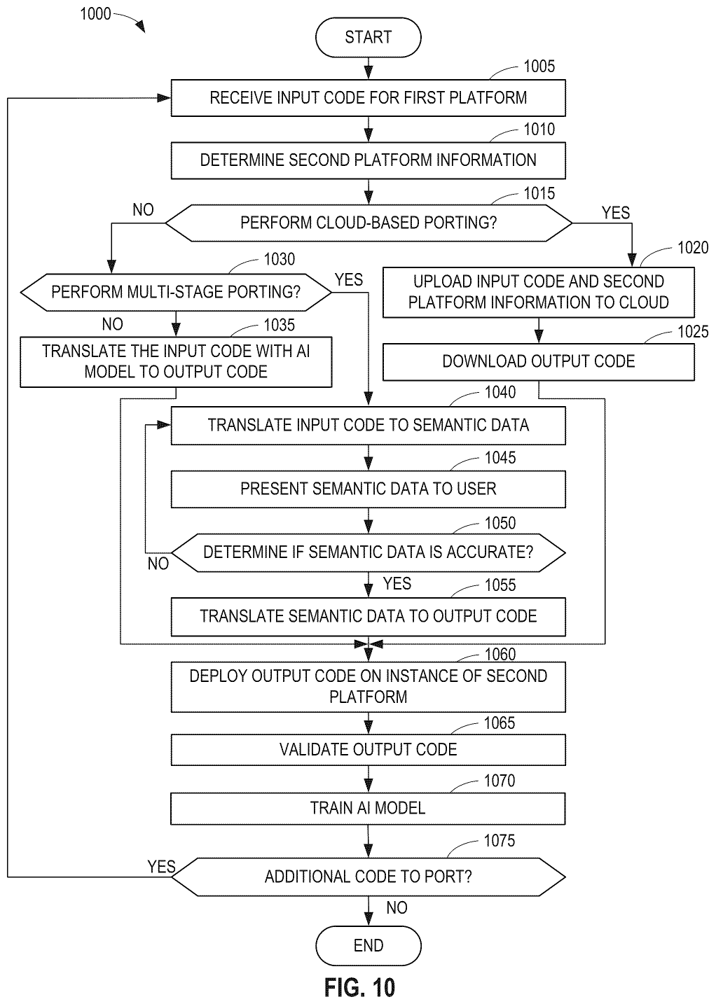

In some examples, the network interface 205 is instantiated by programmable circuitry executing network interface instructions and/or configured to perform operations such as those represented by the flowchart of FIG. 10.

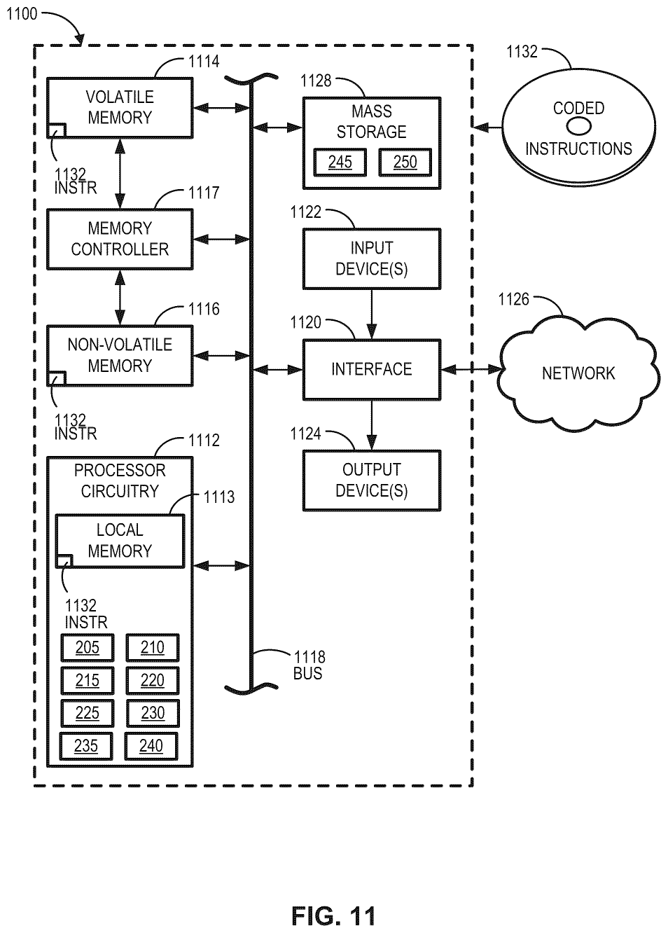

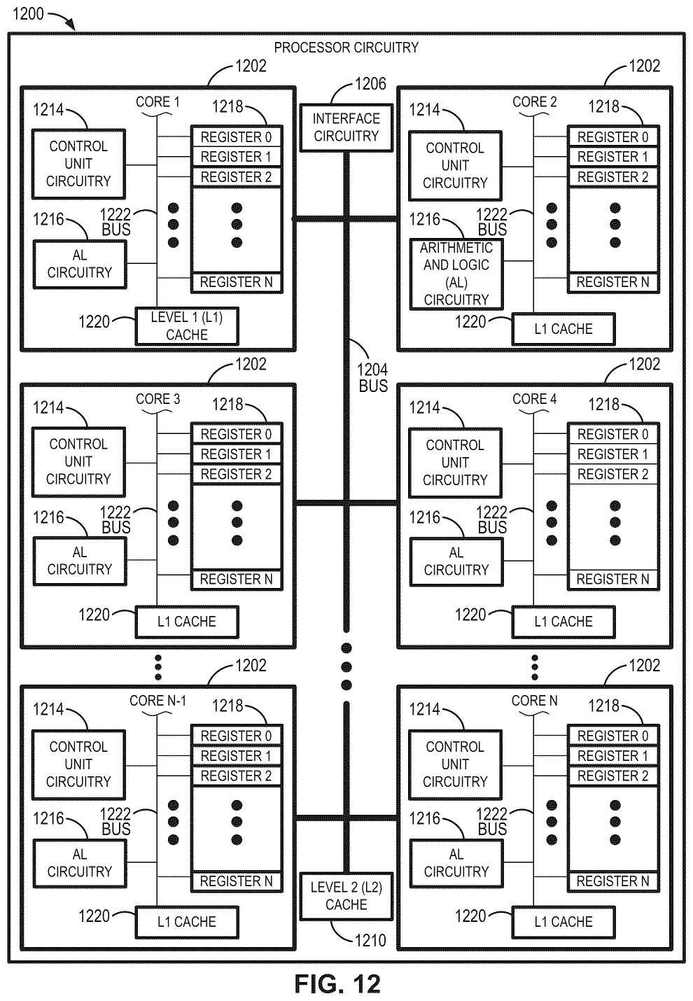

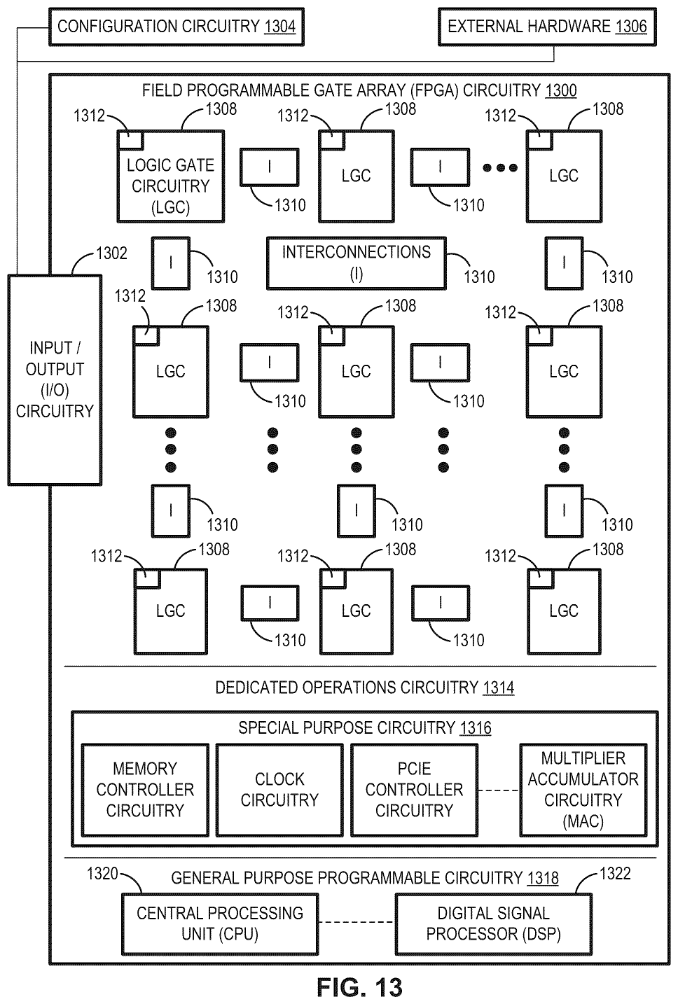

In some examples, the compiler adapter circuitry 120 includes means for transmitting information over a network. For example, the means for transmitting may be implemented by the network interface 205. In some examples, the network interface 205 may be instantiated by programmable circuitry such as the example programmable circuitry 1112 of FIG. 11. For instance, the network interface 205 may be instantiated by the example microprocessor 1200 of FIG. 12 executing machine executable instructions such as those implemented by at least blocks 1020, 1025 of FIG. 10. In some examples, network interface 205 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the network interface 205 may be instantiated by any other combination of hardware, software, and/or firmware. For example, the network interface 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the code detector circuitry 210 is instantiated by programmable circuitry executing code detector instructions and/or configured to perform operations such as those represented by the flowchart of FIG. 10.

In some examples, the compiler adapter circuitry 120 includes means for receiving software code. For example, the means for receiving software may be implemented by code detector circuitry 210. In some examples, the code detector circuitry 210 may be instantiated by programmable circuitry such as the example programmable circuitry 1112 of FIG. 11. For instance, the code detector circuitry 210 may be instantiated by the example microprocessor 1200 of FIG. 12 executing machine executable instructions such as those implemented by at least blocks 1005 and 1075 of FIG. 10. In some examples, code detector circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the code detector circuitry 210 may be instantiated by any other combination of hardware, software, and/or firmware. For example, the code detector circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the target selector circuitry 215 is instantiated by programmable circuitry executing target selector instructions and/or configured to perform operations such as those represented by the flowchart of FIG. 10.

In some examples, the compiler adapter circuitry 120 includes means for determining target platform information. For example, the means for determining target platform information may be implemented by target selector circuitry 215. In some examples, the target selector circuitry 215 may be instantiated by programmable circuitry such as the example programmable circuitry 1112 of FIG. 11. For instance, the target selector circuitry 215 may be instantiated by the example microprocessor 1200 of FIG. 12 executing machine executable instructions such as those implemented by at least block 1010 of FIG. 10. In some examples, target selector circuitry 215 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the target selector circuitry 215 may be instantiated by any other combination of hardware, software, and/or firmware. For example, the target selector circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the translator circuitry 220 is instantiated by programmable circuitry executing translator instructions and/or configured to perform operations such as those represented by the flowchart of FIG. 10.

In some examples, the compiler adapter circuitry 120 includes means for translating software code from a first platform to a second platform. For example, the means for translating software code may be implemented by translator circuitry 220. In some examples, the translator circuitry 220 may be instantiated by programmable circuitry such as the example programmable circuitry 1112 of FIG. 11. For instance, the translator circuitry 220 may be instantiated by the example microprocessor 1200 of FIG. 12 executing machine executable instructions such as those implemented by at least blocks 1015, 1030, 1035, 1040, 1050, 1055 of FIG. 10. In some examples, translator circuitry 220 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the translator circuitry 220 may be instantiated by any other combination of hardware, software, and/or firmware. For example, the translator circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the notification circuitry 225 is instantiated by programmable circuitry executing notification instructions and/or configured to perform operations such as those represented by the flowchart of FIG. 10.

In some examples, the compiler adapter circuitry 120 includes means for notifying users. For example, the means for notifying users may be implemented by notification circuitry 225. In some examples, the notification circuitry 225 may be instantiated by programmable circuitry such as the example programmable circuitry 1112 of FIG. 11. For instance, the notification circuitry 225 may be instantiated by the example microprocessor 1200 of FIG. 12 executing machine executable instructions such as those implemented by at least blocks 1045 and 1050 of FIG. 10. In some examples, notification circuitry 225 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the notification circuitry 225 may be instantiated by any other combination of hardware, software, and/or firmware. For example, the notification circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the deployment circuitry 230 is instantiated by programmable circuitry executing deployment instructions and/or configured to perform operations such as those represented by the flowchart of FIG. 10.

In some examples, the compiler adapter circuitry 120 includes means for deploying output code on a target platform. For example, the means for deploying output code may be implemented by deployment circuitry 230. In some examples, the deployment circuitry 230 may be instantiated by programmable circuitry such as the example programmable circuitry 1112 of FIG. 11. For instance, the deployment circuitry 230 may be instantiated by the example microprocessor 1200 of FIG. 12 executing machine executable instructions such as those implemented by at least block 1060 of FIG. 10. In some examples, deployment circuitry 230 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the deployment circuitry 230 may be instantiated by any other combination of hardware, software, and/or firmware. For example, the deployment circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation circuitry 235 is instantiated by programmable circuitry executing validation instructions and/or configured to perform operations such as those represented by the flowchart of FIG. 10.

In some examples, the compiler adapter circuitry 120 includes means for validating the output code. For example, the means for validating may be implemented by validation circuitry 235. In some examples, the validation circuitry 235 may be instantiated by programmable circuitry such as the example programmable circuitry 1112 of FIG. 11. For instance, the validation circuitry 235 may be instantiated by the example microprocessor 1200 of FIG. 12 executing machine executable instructions such as those implemented by at least block 1065 of FIG. 10. In some examples, validation circuitry 235 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the validation circuitry 235 may be instantiated by any other combination of hardware, software, and/or firmware. For example, the validation circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the training circuitry 240 is instantiated by programmable circuitry executing training instructions and/or configured to perform operations such as those represented by the flowchart of FIG. 10.

In some examples, the compiler adapter circuitry 120 includes means for training the AI model. For example, the means for training the AI model may be implemented by training circuitry 240. In some examples, the training circuitry 240 may be instantiated by programmable circuitry such as the example programmable circuitry 1112 of FIG. 11. For instance, the training circuitry 240 may be instantiated by the example microprocessor 1200 of FIG. 12 executing machine executable instructions such as those implemented by at least block 1070 of FIG. 10. In some examples, training circuitry 240 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the training circuitry 240 may be instantiated by any other combination of hardware, software, and/or firmware. For example, the training circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compiler adapter circuitry 120 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 205, the example code detector circuitry 210, the example target selector circuitry 215, the example translator circuitry 220, the example notification circuitry 225, the example deployment circuitry 230, the example validation circuitry 235, the example training circuitry 240, and/or, more generally, the example compiler adapter circuitry 120 of FIG. 2, may be implemented by hardware alone or by hardware in combination with software and/or firmware. Thus, for example, any of the example network interface 205, the example code detector circuitry 210, the example target selector circuitry 215, the example translator circuitry 220, the example notification circuitry 225, the example deployment circuitry 230, the example validation circuitry 235, the example training circuitry 240, and/or, more generally, the example compiler adapter circuitry 120, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compiler adapter circuitry 120 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed by programmable circuitry to implement and/or instantiate the compiler adapter circuitry 120 of FIG. 2 and/or representative of example operations which may be performed by programmable circuitry to implement and/or instantiate the compiler adapter circuitry 120 of FIG. 2, is shown in FIG. 10. The machine readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 10, many other methods of implementing the example compiler adapter circuitry 120 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

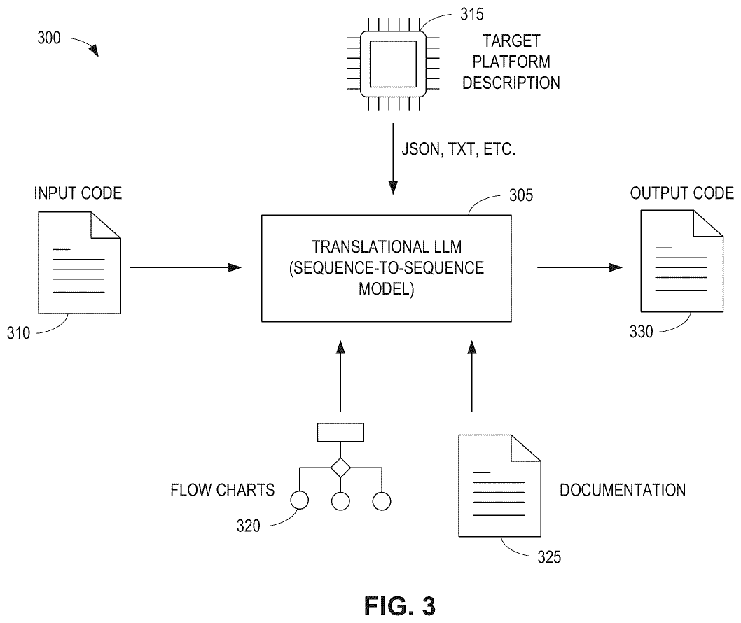

FIG. 3 is a sequence diagram 300 of the inputs and outputs of a single-stage artificial intelligence (AI) model that is used by the compiler adapter circuitry 120 of FIG. 1. The example translator circuitry 220 (FIG. 2) of the example compiler adapter circuitry 120 (FIG. 1) uses a single-stage AI model 305 (e.g., a first AI model, a sequence-to-sequence AI model, a translational LLM, etc.). The example single-stage AI model 305 is to translate a first sequence of code that corresponds to a first platform into a second sequence of code that corresponds to a second platform. The example translator circuitry 220 (FIG. 2) uses the example single-stage AI model 305 to generate the second sequence of code without a generation of intermediate results that are accessible by a user. For example, by translating (e.g., porting, adapting, rewriting, etc.) the first sequence of code directly to the second sequence of code, the example translator circuitry 220 (FIG. 2) is to update the second sequence of code without input (e.g., feedback) from a user. By automatically updating the second sequence of code, the translator circuitry 220 (FIG. 2) is more user-friendly.

Some example implementations of the single-stage AI model 305 include a single-stage translational Large-Language-Model (LLM) that includes an Encoder-Decoder. For example, BART as implemented by Facebook® is a single-stage translational LLM that may be used by the example translator circuitry 220 (FIG. 2). In some examples, the translator circuitry 220 (FIG. 2) uses a Semi-Causal Language Model.

The example translator circuitry 220 (FIG. 2) uses example input code 310, example target platform description 315, example flowcharts 320, and example documentation 325 as inputs for the example single-stage AI model 305. The example input code 310 may be written in any programming language and/or correspond to any platform (e.g., hardware architecture, virtual server, or software system). The example input code 310 is configured for a first platform (e.g., a parallel processing platform), and in the example of FIG. 3, the output code 330 will be configured for a second platform (e.g., a data pipeline platform).

The example target platform description 315 (e.g., target platform information, target platform documentation, target platform features list, etc.) may be represented as a JSON database file, a TXT text file, or any type of file. Some examples of target platform description 315 include hardware characteristics such as the ability of the target platform to support AVX512, AVX2, or AVX, the quality of branch prediction (e.g., if the code is to avoid branches), overlaying computations and memory access requirements (e.g., double buffering), and data architecture of the target platform (e.g., pipelined architecture, data-parallel architecture, etc.). Similar to different programming languages, different hardware platforms use different AI models to achieve the highest metrics (e.g., performance, temperature efficiency, battery life, etc.), even though multi-architecture AI models are possible to be used with different hardware platforms.

The example flowcharts 320 illustrate what the example input code 310 is to accomplish. By augmenting the example single-stage AI model 305 with the example flowcharts 320, the example translator circuitry 220 (FIG. 2) increases the accuracy of the translation of the input code 310 to the example output code 330. For example, the flowcharts 320 describe what the output code 330 is to accomplish, which will be constant, irrespective of the available features from the target platform description 315. The example target platform (e.g., second platform) which runs the output code 330, may have different features than the first platform (e.g., source platform) which has the input code 310.

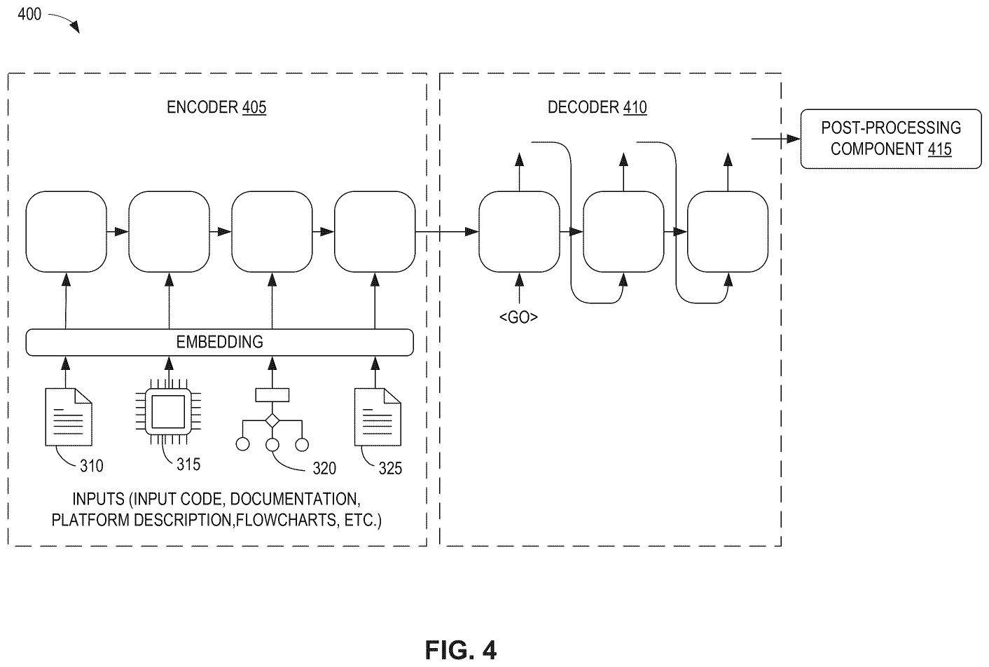

FIG. 4 is a diagram representing an example internal structure 400 of the single-stage AI model 305 of FIG. 3. In the example of FIG. 4, the example single-stage AI model 305 (FIG. 3) is described as including an example encoder 405, an example decoder 410, and an example post-processing component 415. The sequence-to-sequence architecture of the single-stage AI model 305 (FIG. 3) is to use an encoder 405 that is followed by the example decoder 410. The example encoder 405 is to be trained together with the example decoder 410. The example training circuitry 240 (FIG. 2) performs the training of the example encoder 405 and the example decoder 410. For example, the post-processing component 415 may be used to update the vectorization from a first bit number (e.g., 128 bits) to a second bit number (e.g., 256 bits). For example, the post-processing component 415 is used for fine-tuning the output code for different hardware architectures.

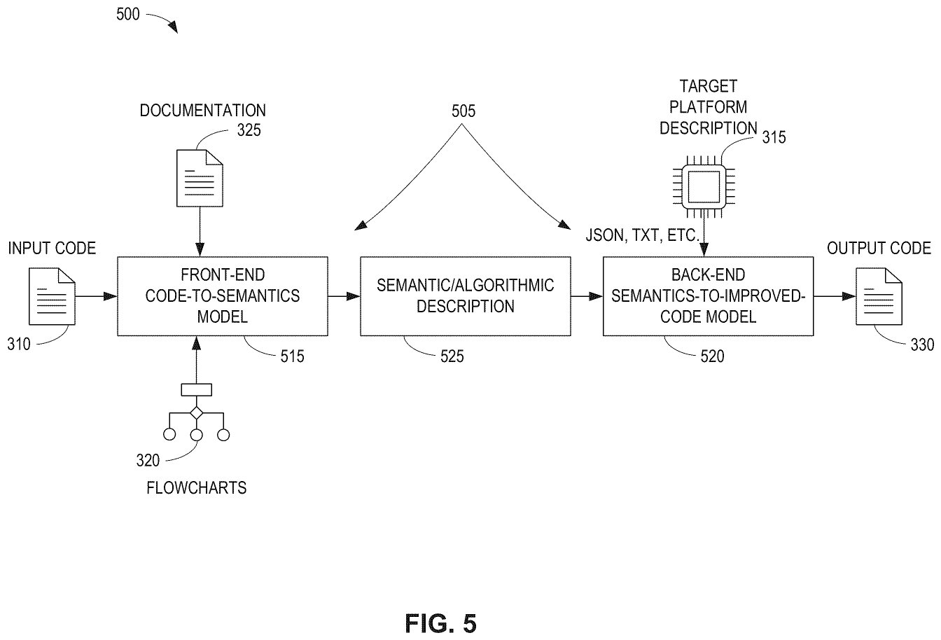

The training circuitry 240 is to train the single-stage AI model 305 (and the multi-stage AI model 505 (FIG. 5)) based on a database that includes naïve code complemented with performance code (e.g., optimized code, platform-specific code). Examples of databases that include naïve code and performance code include the one API™ database as implemented by INTEL® and the Math Kernel Library (MKL). By storing the input code (e.g., the naïve code), the validation circuitry 235 (FIG. 2) can determine if the output code on the target platform provides the same and/or a substantially similar output.

The example training circuitry 240 provides small code pieces (e.g., smaller code sections, smaller code segments) and larger code pieces (e.g., larger code blocks) that may include contextual information to the example translator circuitry 220. By providing the small code pieces and the larger code pieces to the translator circuitry 220, the example training circuitry 240 is able to provide contextual information used by the translator circuitry 220 in porting the code. For example, the input code may include a first equation (e.g., Equation 1). The goal is to improve the performance of the multiplication of Equation 1:

c=a*b Equation 1:

If there is an assumption that a and b of Equation 1 can be arbitrary numbers, then the example translator circuitry 220 and/or the example training circuitry 240 will keep Equation 1 as currently written in the output code 330. However, if the input code 310 includes contextual information such as Equation 2 and Equation 3, the example translator circuitry 220 replaces Equation 1 with Equation 4, as Equation 4 is faster than Equation 1.

α∈N Equation 2:

b=2ⁱ, i∈N Equation 3:

c=a«b Equation 4:

Similar to lines of code, flowcharts can be submitted in the encoder and decoder of FIG. 4, which follow a similar architecture.

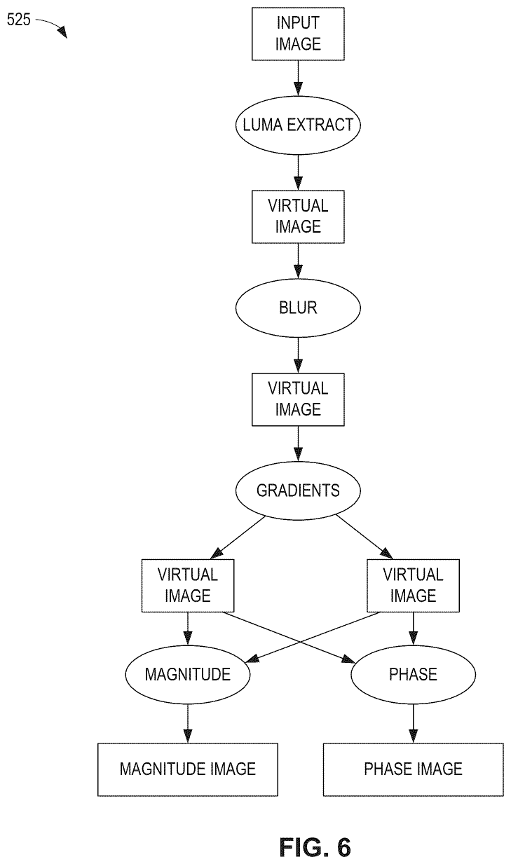

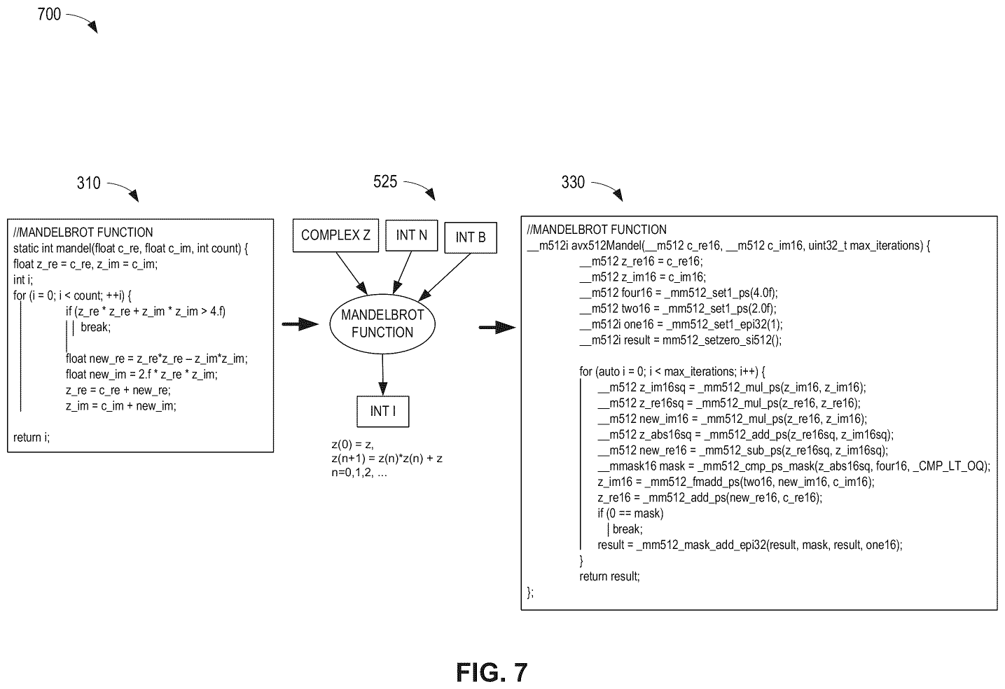

FIG. 5 is a sequence diagram 500 of the inputs and outputs of a multi-stage AI model that is used by the compiler adapter circuitry 120 of FIG. 1. The example translator circuitry 220 (FIG. 2) of the example compiler adapter circuitry 120 (FIG. 1) uses a multi-stage AI model 505 (e.g., autoregressive AI model, a second AI model, etc.). The example multi-stage AI model 505 includes a first portion 515 (e.g., a front-end code-to-semantics model, a first stage) and a second portion 520 (e.g., a back-end semantics-to-code model, a second stage). The example first portion 515 of the multi-stage AI model 505 (e.g., front-end code-to-semantics model) uses the example input code 310, the example flowcharts 320 and the example documentation 325 as inputs to generate the example semantic description 525 (e.g., algorithmic description). An example of the semantic description 525 is shown in FIG. 6 and in FIG. 7. The example semantic description 525 may be represented as a flowchart. The example notification circuitry 225 may present (e.g., display, inform, notify) the semantic description 525 to the user. The example user may verify that the semantic description 525 is accurate based on an understanding of the user of the input code 310. In other examples, the semantic description 525 may be compared to a semantic description that corresponds to the input code 310 to verify that the semantic description 525 is accurate.

After the semantic description 525 is generated, the example translator circuitry 220 uses the second portion 520 of the multi-stage AI model 505 to transform the semantic description 525 into the output code 330. The example second portion 520 of the multi-stage AI model 505 (e.g., back-end semantics-to-code model) uses the semantic description 525 (e.g., high-level description) and the example target platform description 315 to generate the output code 330 that is tuned for the target platform. The multi-stage AI model 505 has increased controllability based on the checkpoint of the semantic description 525 between the first portion 515 (e.g., the first stage of the multi-stage AI model 505) and the second portion 520 (e.g., the second stage of the multi-stage AI model 505). In some examples, the training circuitry 240 trains and/or tunes the example first portion 515 of the multi-stage AI model 505 (e.g., front-end code-to-semantics model) independently from the example second portion 520 of the multi-stage AI model 505 (e.g., back-end semantics-to-code model). In some examples, the second portion 520 of the multi-stage AI model 505 is built from an AI writing program such as GitHub's CoPilot™ AI code writing program which autocompletes segments of code for a user. The AI writing program may then be trained on the platform data store 245 (FIG. 2) to “learn” different platform features and common substitutions from a source platform for the target platform.

FIG. 6 is a diagram representing an example semantic output generated by the multi-stage AI model 505 of FIG. 5. The example semantic description 525 (e.g., semantic output) is illustrated as a flowchart in the example of FIG. 6. The example semantic description 525 is to use OpenVX™ syntax. In some examples, the translator circuitry 220 is to use a high-level flowchart description with blocks. In other examples, the translator circuitry 220 uses code within the blocks of the flowchart. For example, the blocks of the flowchart may be matrix-vector operations, Fourier transforms, Kalman filters, and computer vision functions (e.g., blur).

FIG. 7 is a diagram representing an example of input code, semantic output, and output code corresponding to the multi-stage AI model 505 of FIG. 5. The example input code 310 is a naïve implementation of the Mandelbrot function 700. The example input code 310 is written for a first platform and is a naïve implementation. The example translator circuitry 220 has generated a semantic description 525 for the Mandelbrot function 700 which explains how different complex numbers and integers are input to generate an integer value. The example translator circuitry 220 then uses the example semantic description 525 to generate the output code 330. The example high-level description is then used by the translator circuitry 220 to improve the performance of the code where the output code 330 is able to be used on a platform that has AVX512 as a platform feature.

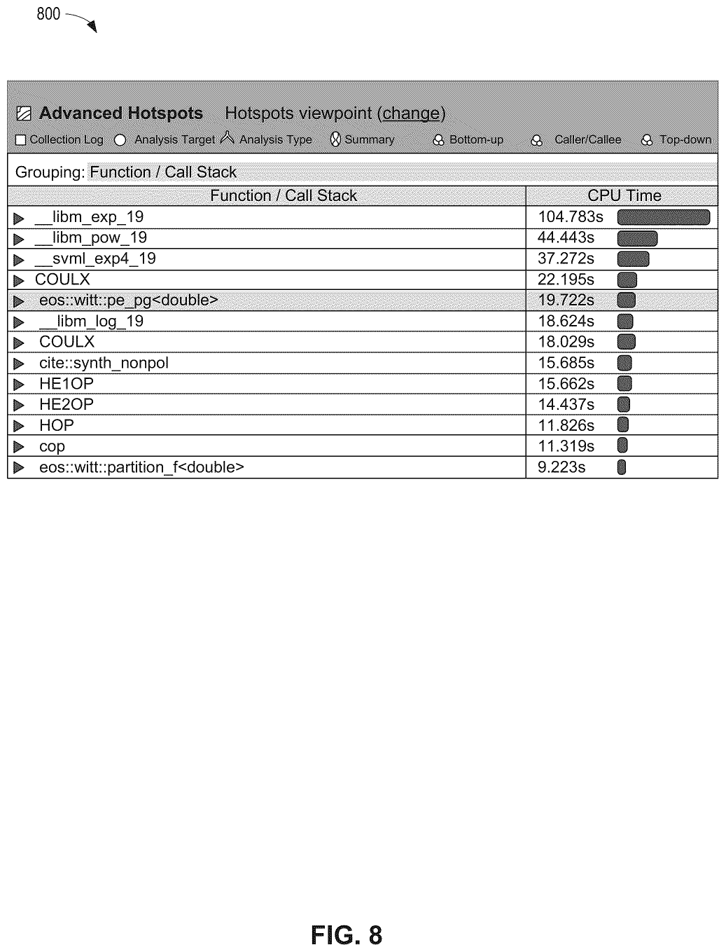

FIG. 8 is an example user interface displaying metrics 800 of the output code comparing the function and the corresponding CPU time. The example validation circuitry 235 performs system analysis (e.g., VTune™ tools) during the training and/or inference of the AI models to generate the metrics 800. For example, the validation circuitry 235 may determine that a first result that corresponds to the input code 310 (FIG. 3) and a second result that corresponds to the output code 330 (FIG. 3) are the same result to verify that the output code 330 (FIG. 3) is accurate when compared to the input code 310 (FIG. 3). In some examples, the validation circuitry 235 (FIG. 2) receives relevant metrics (e.g., CPU time, memory time, etc.) for the various code segments (e.g., machine readable instructions, portions of code). By including relevant metrics for the various code segments, the example validation circuitry 235 (FIG. 2) determines if there are any improvements that use available features in the target platform. In some examples, after the code is executed on the target platform, the metrics are presented to the user by the example notification circuitry 225 (FIG. 2). In some examples, the input code 310 and the output code 330 are both executed on the target platform. In the example of FIG. 8, the metrics 800 include various functions (e.g., libm_exp_19, libm_pow_19, svml_exp4_19, etc.) and various CPU times (e.g., 104.783 seconds, 44.443 seconds, and 37.272 seconds, etc.).

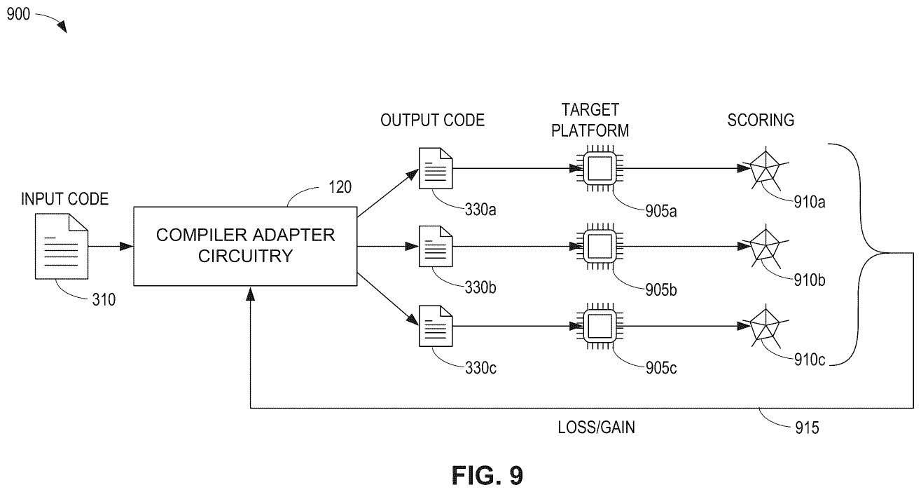

FIG. 9 is an example sequence diagram 900 of compiler adapter circuitry 120 (FIG. 1) using metrics of the output code 330 being executed on instances of the target platforms. The validation circuitry 235 (FIG. 2) of the compiler adapter circuitry 120 (FIG. 1) operates to validate the output code on the various instances of the target platforms. The example compiler adapter circuitry 120 takes the example input code 310 and generates three instances of example output code 330a, 330b, 330c (e.g., multiple versions of the output code 330). The example instances of example output code 330a, 330b, 330c are executed on the target platform 905. In some examples, the instances of example output code 330a, 330b, 330c are executed on three instances of the same target platform 905 (e.g., first instance 905a, second instance 905b, third instance 905c). In other examples, the instances of example output code 330a, 330b, 330c are executed on the same instance of the target platform 905 (e.g., the three instances of code are executed on one platform).

The example validation circuitry 235 (FIG. 2) generates the scores 910a, 910b, 910c based on the three instances of output code 330a, 330b, 330c. In the example of FIG. 10, the example validation circuitry and the example training circuitry are to perform unsupervised training with on-the-fly (e.g., live) access to the target platform 905. The example scores 910a, 910b, 910c are for the different iterations. The example loss metric 915 will be based on the gained improvements that correspond to the relevant metrics (e.g., latency, energy consumption, etc.). The example training circuitry 240 (FIG. 2) uses an unsupervised training approach (e.g., an evolutionary approach). The example compiler adapter circuitry 120 generates multiple versions of the code (e.g., a first version of the output code, a second version of the output code, etc.), which are executed on the target platform 905 (e.g., deployed on the first instance 905a of the target platform), and then scored based on at least one of performance, energy, latency, accuracy and/or other metrics. The gains and/or losses are fed back to the compiler adapter circuitry 120 which trains the AI model for generating the output code 330 from the input code 310. By generating at least a first performance metric that corresponds to the first version of the output code and a second performance metric that corresponds to the second version of the output code, the compiler adapter circuitry 120 is able to train the AI model using an evolutionary protocol that provides the first performance metric and the second performance metric to the AI model.

FIG. 10 is a flowchart representative of example machine readable instructions and/or example operations 1000 that may be executed, instantiated, and/or performed by programmable circuitry to port code from a first platform to a second platform. The example machine-readable instructions and/or the example operations 1000 of FIG. 10 begin at block 1005, at which the example code detector circuitry 210 receives input code for a first platform. For example, the code detector circuitry 210 may receive input code 310 (FIG. 3) for the first platform (e.g., source platform) from a user or a code database. At block 1010, the example target selector circuitry 215 determines second platform information. For example, the target selector circuitry 215 may determine second platform information by selecting a target platform and accessing a list of features associated with the target platform, where the list of features associated with the target platform is stored in the example platform data store 245.

At block 1015, the example translator circuitry 220 determines to perform cloud-based porting. For example, in response to the example translator circuitry 220 determining to perform cloud-based porting (e.g., “YES”), control advances to block 1020. Alternatively, in response to the example translator circuitry 220 determining not to perform cloud-based porting (e.g., “NO”), control advances to block 1030. The example translator circuitry 220 may determine to perform cloud-based porting based on an instruction from the user.

At block 1020, the example network interface 205 uploads the input code and second platform information to the cloud. For example, the network interface 205 may upload the input code 310 (FIG. 3) and the target platform description 315 (FIG. 3) to an artificial intelligence model that is operated by the example cloud-based AI model platform 105 (FIG. 1). After block 1020, the example network interface 205 downloads the output code from the cloud at block 1025. For example, the network interface 205 may download the output code 330 (FIG. 3) from the cloud-based AI model platform 105 (FIG. 1). Control advances to block 1060.

In response to the determination that cloud-based porting is not to be performed (e.g., block 1015 returning a result of “NO”), the example translator circuitry 220 determines whether to perform multi-stage porting. (Block 1030). For example, in response to the translator circuitry 220 determining to perform multi-stage porting (e.g., “YES”), control advances to block 1040. Alternatively, in response to the translator circuitry 220 determining not to perform multi-stage porting (e.g., “NO”), control advances to block 1035. The example translator circuitry 220 may determine to perform multi-stage porting based on a level of user involvement. For example, a user may select a low level of involvement and the example translator circuitry 220 will determine to not perform multi-stage porting (e.g., determine to perform single-stage porting). Alternatively, a user may select a high level of involvement, and the example translator circuitry 220 will determine to perform multi-stage porting and present the user with further decisions.

At block 1035, the translator circuitry 220 translates the input code with an artificial intelligence model. For example, the translator circuitry 220 may translate the input code 310 (FIG. 3) with a single-stage AI model 305 (FIG. 3) (e.g., a sequence-to-sequence AI model) to generate output code 330 (FIG. 3). Control advances to block 1060.

At block 1040, the translator circuitry 220 translates the input code to semantic data. For example, the translator circuitry 220 may translate the input code 310 (FIG. 5) with a first portion 515 of a multi-stage AI model 505 (FIG. 5) (e.g., a front-end code-to-semantics AI model) to generate a semantic description 525 (FIG. 5). At block 1045, the notification circuitry 225 presents the semantic data to a user. For example, the notification circuitry 225 may present the semantic description 525 (FIG. 5) to a user for verification that the semantic description 525 (FIG. 5) is accurate as compared to the input code 310 (FIG. 5).

At block 1050, the example notification circuitry 225 determines if the semantic data is accurate. For example, in response to the notification circuitry 225 determining that the semantic data is accurate (e.g., “YES”), control advances to block 1055. Alternatively, in response to the notification circuitry 225 determining that the semantic data is not accurate (e.g., “NO”), control returns to block 1040 for a subsequent translation of the input code to semantic data. The example notification circuitry 225 may determine whether the semantic data is accurate compared to the input code based on a determination received from a user.

At block 1055, the example translator circuitry 220 translates the semantic data to output code. For example, the translator circuitry 220 may translate the semantic description 525 (FIG. 5) to the example output code 330 (FIG. 5) using a second portion 520 of the multi-stage AI model 505 (e.g., a back-end semantics-to-improved code model). Control advances to block 1060.

At block 1060, the example deployment circuitry 230 deploys the output code on an instance of the second platform. For example, the deployment circuitry 230 may deploy a first instance of the output code 330a on a first instance 905a of a target platform 905.

At block 1065, the example validation circuitry 235 validates the output code. For example, the validation circuitry 235 may validate the output code 330 (FIG. 3) by comparing a result of the output code 330 (FIG. 3) with a result of the input code 310 (FIG. 3) to confirm that the output code 330 (FIG. 3) generates an accurate result.

At block 1070, the example training circuitry 240 trains the AI model. For example, the training circuitry 240 may provide result data to the cloud-based AI model platform 105 (FIG. 2), the single stage porting AI model (FIG. 3) or the multi-stage porting model (FIG. 5). The feedback given to the AI mode is used by the training circuitry 240 to train and/or tune the AI models.

At block 1075, the example code detector circuitry 210 determines if there is any additional code to port. For example, in response to the code detector circuitry 210 determining that there is additional code to port (e.g., “YES”), control returns to block 1005. Alternatively, in response to the code detector circuitry 210 determining that there is not additional code to port (e.g., “NO”), the instructions 1000 end. In some examples, the instructions 1000 continue monitoring to receive input code, rather than terminating after block 1075.

FIG. 11 is a block diagram of an example programmable circuitry platform 1100 structured to execute and/or instantiate the example machine-readable instructions and/or the example operations of FIG. 10 to implement the compiler adapter circuitry 120 of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example network interface 205, the example code detector circuitry 210, the example target selector circuitry 215, the example translator circuitry 220, the example notification circuitry 225, the example deployment circuitry 230, the example validation circuitry 235, and the example training circuitry 240.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIG. 10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowchart of FIG. 10 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIG. 10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart of FIG. 10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart of FIG. 10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 10. As such, the FPGA circuitry 1300 may be configured and/or structured to effectively instantiate some or all of the operations/functions corresponding to the machine readable instructions of the flowchart of FIG. 10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIG. 10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIG. 10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIG. 10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 10, and/or an ASIC may be configured and/or structured to perform third operation(s)/function(s) corresponding to a third portion of the machine readable instructions represented by the flowcharts of FIG. 10.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

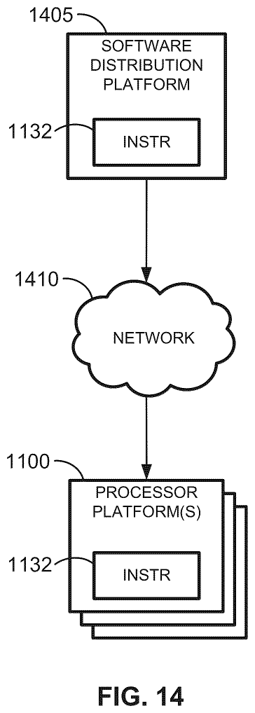

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIG. 10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 10, may be downloaded to the example programmable circuitry platform 1100, which is to execute the machine readable instructions 1132 to implement the compiler adapter circuitry 120. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that compile portable code for specific hardware. Disclosed systems, apparatus, articles of manufacture, and methods improve the efficiency of using a computing device by allowing the computing device to use available features in executing machine readable instructions. The target computing device has an increased performance, battery life, and accuracy based on the disclosed systems, apparatus, articles of manufacture which have translated the code from a source platform to a target platform. In addition, the disclosed systems, apparatus, articles of manufacture improve the efficiency of a computing device by reducing wasted processor cycles to translate the code. By allowing a user to inspect semantic data at a checkpoint between the translation of the code, the disclosed systems, apparatus, articles of manufacture reduce errors in generating inaccurate output code. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to compile portable code for specific hardware are disclosed herein. Further examples and combinations thereof include the following:

Example 1 includes an apparatus including computer readable instructions, and programmable circuitry to at least one of execute or instantiate the instructions to receive input code, the input code written for operation on a first platform, determine a target platform, the target platform different than the first platform, and translate, via an artificial intelligence (AI) model, the input code to output code, the output code written for operation on the target platform.

Example 2 includes the apparatus of example 1, wherein the AI model is a cloud-based AI model, and the programmable circuitry is to upload the input code to the cloud-based AI model and download the output code from the cloud-based AI model.

Example 3 includes the apparatus of example 1, wherein the AI model is executed locally to the apparatus.

Example 4 includes the apparatus of example 1, wherein the programmable circuitry is to translate the input code using a sequence-to-sequence AI model, the sequence-to-sequence AI model to translate the input code to the output code without generation of an intermediate result.

Example 5 includes the apparatus of example 3, wherein the programmable circuitry is to translate the input code using a multi-stage AI model, the multi-stage AI model to include at least a first stage of translating the input code to semantic data, and a second stage of translating the semantic data to the output code.

Example 6 includes the apparatus of example 5, wherein the programmable circuitry is to use at least one of the input code, documentation corresponding to the input code, and a flowchart corresponding to the input code as an input to generate the semantic data.

Example 7 includes the apparatus of example 5, wherein the programmable circuitry is to use at least one of target platform information and the semantic data as inputs to generate the output code.

Example 8 includes the apparatus of example 5, wherein the programmable circuitry is to cause display of a message to inform a user that the semantic data is available for inspection, and after user input, the programmable circuitry is to adjust the semantic data.

Example 9 includes the apparatus of example 1, wherein the programmable circuitry is to cause deployment of the output code on a first instance of the target platform, and record a performance metric of the output code in operation on the first instance of the target platform.

Example 10 includes the apparatus of example 9, wherein the programmable circuitry is to compare a first output of the input code and a second output of the output code, the comparison to validate the output code based on a determination of whether the output code generates a second output that corresponds to the first output of the input code.

Example 11 includes the apparatus of example 9, wherein the programmable circuitry is to train the AI model based on the performance metric of the output code, the performance metric to include at least one of accuracy, temperature, power, and speed.

Example 12 includes the apparatus of example 9, wherein the programmable circuitry is to generate, by using the AI model, at least a first version of the output code and a second version of the output code, deploy at least the first version of the output code and the second version of the output code on the first instance of the target platform, record at least a first performance metric that corresponds to the first version of the output code and a second performance metric that corresponds to the second version of the output code, and train the AI model based on an evolutionary protocol that provides at least the first performance metric and the second performance metric to the AI model.

Example 13 includes the apparatus of example 1, wherein the programmable circuitry is to compare features available in the target platform with the first platform, wherein the first platform is a first hardware platform, and the target platform is a second hardware platform.

Example 14 includes the apparatus of example 13, wherein the programmable circuitry is to determine a meaning corresponding to a first section of the input code and rewrite the first section of the input code to use a first feature that is available in the target platform, the first feature absent from the first platform.

Example 15 includes the apparatus of example 1, wherein the programmable circuitry is to generate the output code as binary code.

Example 16 includes at least one non-transitory machine readable storage medium including instructions to cause at least one processor circuitry to at least receive input code, the input code written for operation on a first platform, determine a target platform, the target platform different than the first platform, and translate, using an artificial intelligence (AI) model, the input code to output code, the output code written for operation on the target platform.

Example 17 includes the at least one non-transitory machine readable storage medium of example 16, wherein the instructions cause one or more of the at least one processor circuitry to translate the input code using a sequence-to-sequence AI model, the sequence-to-sequence AI model to translate the input code to the output code without generation of an intermediate result.

Example 18 includes the at least one non-transitory machine readable storage medium of example 16, wherein the instructions cause one or more of the at least one processor circuitry to translate the input code using a multi-stage AI model, the multi-stage AI model to include a first stage of translating the input code to semantic data, and a second stage of translating the semantic data to the output code.

Example 19 includes a method for porting code from a first platform to a second platform, the method including receiving, by executing an instruction with a processor, input code written for operation on a first platform, determining, by executing an instruction with the processor, a target platform, the target platform different than the first platform, and translating, by executing an instruction with the processor, the input code to output code, the output code written for operation on the target platform.

Example 20 includes the method of example 19, further including validating, by executing an instruction with the processor, the output code by comparing a first output and a second output, the first output generated based on the input code and a second output generated based on the output code.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
computer readable instructions; and
programmable circuitry to at least one of execute or instantiate the instructions to:
receive input code, the input code written for operation on a first platform;
determine a target platform, the target platform different than the first platform; and
translate, via an artificial intelligence (AI) model, the input code to output code, the output code written for operation on the target platform.

2. The apparatus of claim 1, wherein the AI model is a cloud-based AI model, and the programmable circuitry is to upload the input code to the cloud-based AI model and download the output code from the cloud-based AI model.

3. The apparatus of claim 1, wherein the AI model is executed locally to the apparatus.

4. The apparatus of claim 1, wherein the programmable circuitry is to translate the input code using a sequence-to-sequence AI model, the sequence-to-sequence AI model to translate the input code to the output code without generation of an intermediate result.

5. The apparatus of claim 3, wherein the programmable circuitry is to translate the input code using a multi-stage AI model, the multi-stage AI model to include at least:
a first stage of translating the input code to semantic data; and
a second stage of translating the semantic data to the output code.

6. The apparatus of claim 5, wherein the programmable circuitry is to use at least one of the input code, documentation corresponding to the input code, and a flowchart corresponding to the input code as an input to generate the semantic data.

7. The apparatus of claim 5, wherein the programmable circuitry is to use at least one of target platform information and the semantic data as inputs to generate the output code.

8. The apparatus of claim 5, wherein the programmable circuitry is to cause display of a message to inform a user that the semantic data is available for inspection, and after user input, the programmable circuitry is to adjust the semantic data.

9. The apparatus of claim 1, wherein the programmable circuitry is to:
cause deployment of the output code on a first instance of the target platform; and
record a performance metric of the output code in operation on the first instance of the target platform.

10. The apparatus of claim 9, wherein the programmable circuitry is to compare a first output of the input code and a second output of the output code, the comparison to validate the output code based on a determination of whether the output code generates a second output that corresponds to the first output of the input code.

11. The apparatus of claim 9, wherein the programmable circuitry is to train the AI model based on the performance metric of the output code, the performance metric to include at least one of accuracy, temperature, power, and speed.

12. The apparatus of claim 9, wherein the programmable circuitry is to:
generate, by using the AI model, at least a first version of the output code and a second version of the output code;
deploy at least the first version of the output code and the second version of the output code on the first instance of the target platform;
record at least a first performance metric that corresponds to the first version of the output code and a second performance metric that corresponds to the second version of the output code; and
train the AI model based on an evolutionary protocol that provides at least the first performance metric and the second performance metric to the AI model.

13. The apparatus of claim 1, wherein the programmable circuitry is to compare features available in the target platform with the first platform, wherein the first platform is a first hardware platform, and the target platform is a second hardware platform.

14. The apparatus of claim 13, wherein the programmable circuitry is to determine a meaning corresponding to a first section of the input code and rewrite the first section of the input code to use a first feature that is available in the target platform, the first feature absent from the first platform.

15. The apparatus of claim 1, wherein the programmable circuitry is to generate the output code as binary code.

16. At least one non-transitory machine readable storage medium comprising instructions to cause at least one processor circuitry to at least:
receive input code, the input code written for operation on a first platform;
determine a target platform, the target platform different than the first platform; and
translate, using an artificial intelligence (AI) model, the input code to output code, the output code written for operation on the target platform.

17. The at least one non-transitory machine readable storage medium of claim 16, wherein the instructions cause one or more of the at least one processor circuitry to translate the input code using a sequence-to-sequence AI model, the sequence-to-sequence AI model to translate the input code to the output code without generation of an intermediate result.

18. The at least one non-transitory machine readable storage medium of claim 16, wherein the instructions cause one or more of the at least one processor circuitry to translate the input code using a multi-stage AI model, the multi-stage AI model to include:
a first stage of translating the input code to semantic data; and
a second stage of translating the semantic data to the output code.

19. A method for porting code from a first platform to a second platform, the method comprising:
receiving, by executing an instruction with a processor, input code written for operation on a first platform;
determining, by executing an instruction with the processor, a target platform, the target platform different than the first platform; and
translating, by executing an instruction with the processor, the input code to output code, the output code written for operation on the target platform.

20. The method of claim 19, further including validating, by executing an instruction with the processor, the output code by comparing a first output and a second output, the first output generated based on the input code and a second output generated based on the output code.
